(19) United States
(12) Patent Application Publication
(10) Pub. No.: US 2015/0169898 A1
(43) Pub. Date: Jun. 18, 2015

(54) Method and System for Transferring Personal Memories and Directives into Digital Representations to be Accessible by Beneficiaries

(71) Applicant: IMEMORIZED INC., Victoria (CA)

(72) Inventor: Paul Lembcke, Victoria (CA)

(21) Appl. No.: 14/105,458

(22) Filed: Dec. 13, 2013

(51) Int. Cl. G06F 21/62; G06Q 50/18

(52) U.S. Cl. CPC G06F 21/6245; G06Q 50/186

(57) ABSTRACT

Voice and video memories are created by in an individual subscriber system and transferred in encrypted format via a communications network to a secure proprietary server system. The server system receives the subscriber information including identification by user name and unique one-time password initiated by the user system. The server system continuously authenticates the user through biometric profiling of the keystroke dynamic inherent in user typing rhythms. The server system places the user's digitized and encrypted memories in a secure storage capsule analogous to a virtual safety deposit box, Subsequent to the confirmed death or incapacitation of the user, the server system allows identified beneficiaries to access specific user memories after successfully challenging question and answer processes previously set by the subscriber.

This application claims the benefit under 35 U.S.C. 119(e) of U.S. provisional application Ser. No. 61/739,281, filed Dec. 19, 2012.

### FIELD OF THE INVENTION

The present invention relates to a computer method and system for distributing memories to beneficiaries using the Internet.

### BACKGROUND

Modern Internet communications networks connect many computers and computer networks. Electronic mail and the World Wide Web (“WWW” or “Web”) are connected through communications links and allow remote user computer systems to send information to a Web page of the WWW that is uniquely identifiable by a Uniform Resource Locator (“URL”). Users view a specific Web page by sending a Hyper Text Transfer Protocol (“HTTP”) request to the URL of the Web site. The Web server supporting the unique Web site receives the request and sends the Web page to the user's computer. A special-purpose application in the user's computer called a browser, receives the information from the Web site and displays it on the user's screen. Hypertext Markup Language (“HTML”) elements are the building blocks of all Web sites that allow information to be contained on the site to define its structure and other items that make up the text, lists, links and other contents of the Web page.

Computers store information in digital format on internal hard drives, external drives and on removable storage devices like a USB flash drives (data storage devices that include flash memory with an integrated Universal Serial Bus (USB) interface). Many social networking sites also provide remote computing and storage capacity as a service to a community of users. These storage systems, often referred to as “cloud” computing, are efficient and inexpensive but require that a user's information be stored along with information from many other users. Since communications often contain sensitive information (e.g.: bank account and credit card numbers), users want to ensure security of their information. Security is of concern because information transmitted over the Internet may progress through several computers and servers and be susceptible to interception by unscrupulous individuals. Even encryption techniques are not a guarantee against hacking. Similarly, when information is stored in the cloud, it is vulnerable to attack because there is so much data available that sophisticated hacking techniques have a higher probability of being successful.

### SUMMARY OF THE INVENTION

According to one aspect of the invention there is provided a computer implemented system for storing digital memories of a subscriber using an internet enabled subscriber computing device for access by a beneficiary using an internet enabled beneficiary computing device, the system comprising:

a proprietary server comprising a subscriber zone associated with the subscriber and which includes subscriber authorization criteria associated therewith and at least one beneficiary zone associated with said subscriber zone which includes beneficiary authorization criteria relating to a beneficiary associated therewith;

a communication interface arranged to provide sole communication between the proprietary server and the Internet, the communication interface comprising:
a subscriber authentication component arranged to authorize a subscriber to upload digital memories over the internet to the subscriber zone of the proprietary server and to transfer digital memories from the subscriber zone to one beneficiary zone of the proprietary server associated with said subscriber zone using the subscriber computing device in response to the subscriber authorization criteria being met; and
a beneficiary authentication component arranged to authorize a beneficiary to access digital memories only from the beneficiary zone associated therewith using the beneficiary computing device in response to the beneficiary authorization criteria being met.

Modern communication systems according to the present invention provided an alternative method to the traditional way for an individual to share information with beneficiaries by a last will and testament. A subscriber's memories in the form of voice, video or data are stored in digital form and are encrypted with a unique random number (salt) and a number of hash iterations to be sent to a highly-secure proprietary server. The Web site provides authentication for both the subscriber for storing the encrypted memories and for designated beneficiaries to retrieve the digital memories after appropriate conditions have been met as described in further detail herein.

Preferably the beneficiary authentication component is arranged to be activated only in response to a prescribed subscriber condition criteria being met.

The prescribed subscriber condition criteria preferably comprises a confirmed death of the subscriber, or alternatively an incapacitation of the subscriber as confirmed by a preselected group of incapacitation contacts.

Preferably the subscriber authentication component of the communication interface comprises a website server system.

The beneficiary authentication component of the communication interface may also comprise a website server system.

The subscriber authorization criteria preferably includes an identity of the subscriber encrypted with a unique random number and a number of hash iterations.

The subscriber authorization criteria may include a machine identification corresponding to the subscriber computing device.

The subscriber zone preferably comprises a storage zone arranged to receive digital memories from the subscriber computing device and a secure zone arranged to receive digital memories from the storage zone prior to transfer to the beneficiary zone in which each of the storage zone and the secure zone have respective subscriber authorization criteria associated therewith.

The subscriber zone may further comprise a data transfer component arranged to transfer digital memories only from the storage zone to the secure zone if the subscriber authorization criteria associated with the storage zone has been met but the subscriber authorization criteria associated with the secure zone has not been met.

The subscriber authorization criteria associated with the secure zone preferably require a higher degree of authorization than the subscriber authorization criteria associated with the storage zone.

The subscriber authorization criteria associated with the secure zone may include biometric rhythm criteria associated with the subscriber.

Preferably the subscriber authorization criteria associated with the secure zone includes a one-time access code which is valid for a single use. In this instance the subscriber authorization component may be arranged to generate the one-time access code and transmit the one-time access code to the subscriber independently of the communication interface.

When used with a plurality of beneficiaries using respective beneficiary computing devices, preferably the proprietary server includes a plurality of beneficiary zones associated with said subscriber zone in which the plurality of beneficiary zones have different beneficiary authorization criteria associated therewith corresponding to different ones of the beneficiaries being authorized to access the digital memories stored therein.

The beneficiary authorization criteria may include challenge questions prescribed by the subscriber which are personalized to the respective beneficiary.

The beneficiary authorization criteria may also include a one-time access code which is valid for a single use. In this instance, the beneficiary authorization component may be arranged to generate the one-time access code and transmit the one-time access code to the beneficiary independently of the communication interface.

The proprietary server preferably further comprises a time capsule component associated with said subscriber zone which is arranged to receive digital memories from the subscriber zone and store the digital memories in encrypted form therein. Preferably the time capsule component is arranged to provide an authorized beneficiary access to the information upon expiry of a prescribed duration.

The system may further include a subscriber storage tool arranged to be executed on the subscriber computing device in which the subscriber storage tool is arranged to automatically transfer digital memories in encrypted form from the subscriber computing device to the subscriber zone in response to subscriber interactions with the subscriber computing device.

When the subscriber zone comprises a storage zone arranged to receive digital memories from the subscriber storage tool and a secure zone arranged to receive digital memories from the storage zone prior to transfer to the beneficiary zone, the subscriber storage tool may be the only authorized to transfer digital memories to the storage zone.

According to a second aspect of the present invention there is provided a method for storing digital memories of a subscriber for access by a beneficiary using an internet enabled beneficiary computing device, the method comprising:

providing an internet enabled subscriber computing device;

providing a proprietary server comprising a subscriber zone associated with the subscriber and which includes subscriber authorization criteria associated therewith and at least one beneficiary zone associated with said subscriber zone which includes beneficiary authorization criteria relating to the beneficiary associated therewith;

providing a communication interface arranged to provide sole communication between the proprietary server and the internet, the communications interface comprising a subscriber authentication component and a beneficiary authentication component;

receiving digital memories uploaded over the internet to the subscriber zone of the proprietary server from a subscriber using the subscriber computing device and being authorized by the subscriber authentication component in response to subscriber authorization criteria being met;

transferring the digital memories from the subscriber zone to at least one beneficiary zone associated with said subscriber zone in response to instructions from the subscriber using the subscriber computing device and being authorized by the subscriber authentication component in response to subscriber authorization criteria being met;

arranging only the digital memories from the beneficiary zone associated the beneficiary to be accessed by the beneficiary authorized by the beneficiary authentication component in response to beneficiary authorization criteria being met.

According to a further aspect of the present invention there is provided a method in a subscriber's computer system for converting memories into digital representations accessible by designated beneficiaries, the method comprising:

providing a Web site server system with an identifier of the subscriber encrypted with a unique random number (salt) and a number of hash iterations and identification of the subscriber's computer system and mobile devices;

providing sufficient data input to allow biometric authentication;

converting voice, video and data memories into digital format accessible by designated beneficiaries;

recording a subscriber's selected memories in a contiguous location on proprietary servers; and

allowing access to the subscriber's memories by previously-designated beneficiaries after successful completion of a security challenge process designed by the subscriber.

According to another aspect of the present invention there is provided a method in a server system for providing access to a subscriber's memories by designated beneficiaries, the method comprising:

a component that receives from a subscriber's system a subscriber identifier encrypted with a unique salt (random bits) and a number of hash iterations;

a component that receives machine identification numbers of the subscriber's computer equipment;

a component that receives subscriber's memories in voice, video and typewritten form;

a component that converts the memories to digital format and places them in secure memory capsules on proprietary servers; and

a component that permits a designated beneficiary to share in specific memories after passing challenge testing.

One embodiment of the invention will now be described in conjunction with the accompanying drawings in which:

### BRIEF DESCRIPTION OF THE DRAWINGS

FIG. 1 is a schematic representation of the system according to the present invention for storing digital memories for subsequent access by beneficiaries;

FIG. 2 is a schematic representation of the process for initially subscribing to the system;

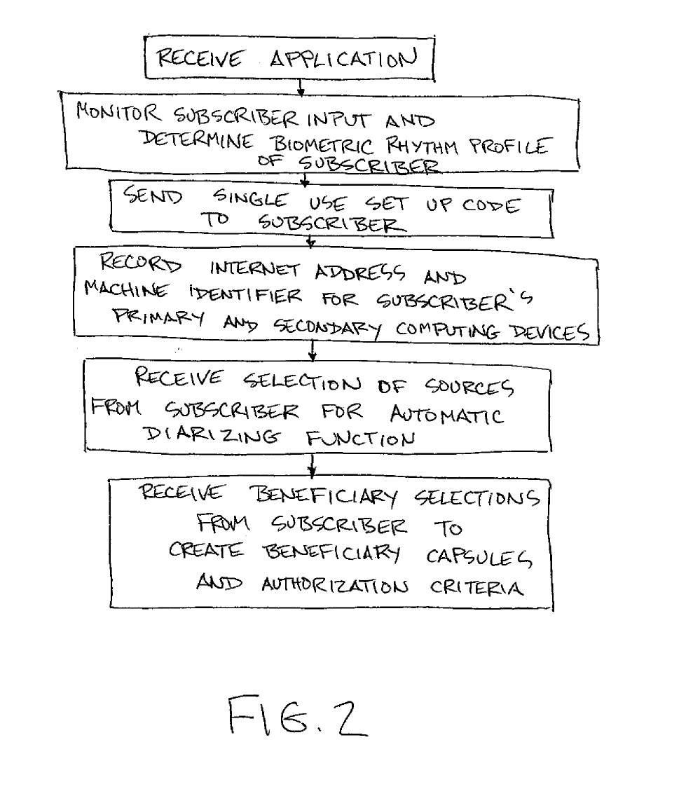

FIG. 3 is a schematic representation of the process for storing digital memories on the proprietary servers of the system; and

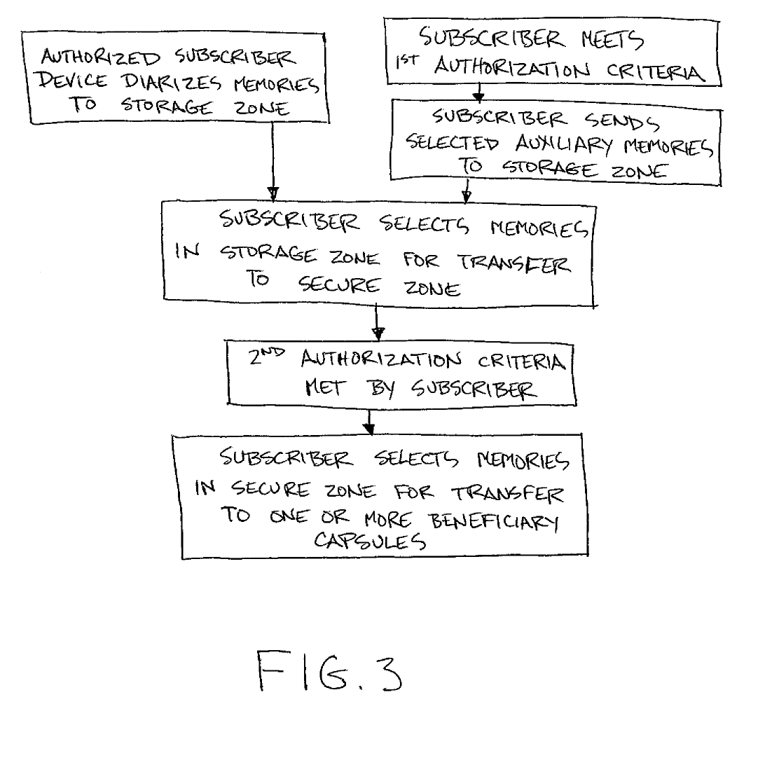

FIG. 4 is a schematic representation of the process for retrieval of digital memories by designated beneficiaries.

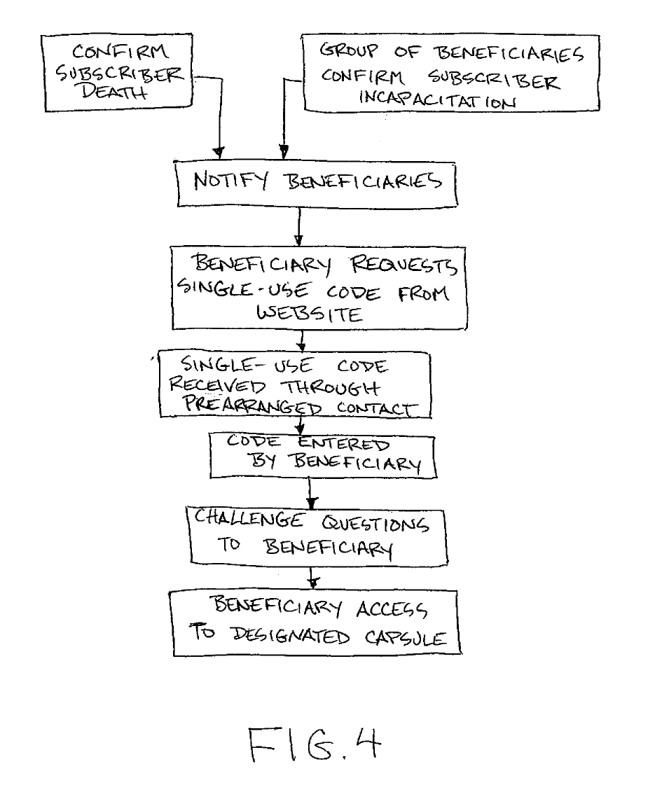

In the drawings like characters of reference indicate corresponding parts in the different figures.

### DETAILED DESCRIPTION

The traditional way for an individual to share information with beneficiaries is through a last will and testament. Modern communication systems present an alternative method. A subscriber's memories are captured in voice, video or data; are encrypted with a unique random number (salt) and a number of hash iterations and sent to a highly-secure proprietary server. The Web site authenticates the subscriber through the username and password and through the biometric rhythm of the data input as compared to the user profile stored on the Web site server. The encrypted memories are stored in segregated locked capsules that are impenetrable to anyone but the subscriber and designated beneficiaries. Beneficiaries are required to answer a series of questions posed by the subscriber with the answers being common knowledge to the user and the beneficiary, and presumably, only to the subscriber and beneficiary.

In the subscription process, the subscriber decides which beneficiaries will have access to the Web site, the specific memories the beneficiaries will be able to access and how strong the security needs to be for the beneficiary to access the specific memory. The Web site provides the subscriber with a menu of choices and pre-set questions with recommendations on how to create subscriber-specific queries. The user controls the strength of security for access to information stored in capsules in the virtual safety deposit box. Some subscribers will be extremely security-conscious and will set very stringent access rules; others will be more relaxed and will set simpler security access questions. An additional option allows creation of time capsules for specific memories. The subscriber pays-forward to a specific future date when the capsule automatically opens and distributes a notification and an encrypted access code to inform registered beneficiaries of the secured memories available to them at the Web site.

An individual wishing to become a subscriber will sign up by completing an application and paying a fee. Once payment is processed, the subscriber's mouse and keystroke dynamics are monitored and processed to provide a continuous authentication profile. The process does not need to know the letters and characters submitted thus preserving the integrity and security of the subscriber's encrypted password. A one-time access code is transmitted to a pre-designated email address established in the subscription process. During initiation, the Internet address and machine identifier for a main computer and frequently-used mobile or portable devices of a subscriber are captured by the Web site server. This process allows the Web site program to instantly recognize the subscriber during log in and providing the fastest most secure encrypted access. In the event that a subscriber logs in from a new device, a secure question and answer challenge process will allow access to accredited users.

The Web site platform contains a subscriber's zone to provide easy, fast, secure, encrypted access for day-to-day activity, a secure zone for permanent memory message capsule storage and a zone to identify designated beneficiaries who will be allowed to share a subscriber's memories.

The subscriber's zone contains files where the subscriber can scan and post important documents like passports, driver's license, account and credit card numbers, user names and passwords, etc. The subscriber's zone also includes files with fill-in forms for listing user names, passwords, account numbers, PINs, etc. There is a mobile version and access through apps for iPhone, iPad, Android and tablet devices. Personal and business calendars, notes and memos, files, voice clips and videos can all be included. For individuals with less-than-perfect memories, the Web site provides the capability to create verbal memories and reminders throughout the day.

Cell phones and other mobile devices are likely to be the predominant access to the iMemorized portal. The easy-access diary feature is an important productivity tool. Voice memos, photographs, video clips and scans are automatically encrypted, time-stamped and posted to the secure daily diary. This productivity enhancing system makes a chronological record of dictated reminders, photographs of job sites to document work progress, scans of receipts for tax purposes, etc. Mobile devices can record meetings or notes dictated after the meeting as reminders or action lists. The daily diary automatically encrypts the information and displays an icon showing the type of activity in a particular time slot.

The daily diary can also be used to make a permanent encrypted chronological record of personal thoughts and activities. All diary items are automatically backed-up in the virtual safety deposit box. The current month, previous month and next month (for appointments) are maintained on the mobile device with full access to attachments. Diary photos and videos are archived separately from the device register. This allows general photographs to be shared while special or confidential photos can be encrypted and stored in a secure personal diary and deleted from the photo album on the device. Stored items can be listed and searched from chronological albums of attachments or can be accessed by clicking on the icon displayed on date the item was created.

Most permanent data entry, including scans, audio and video, are processed through the subscriber daily activity zone. Each memory can be selected for upload to permanent secure storage and decisions can be made about retaining a copy of the memory in the subscriber's daily work zone to be available for access from mobile devices. If secure storage is selected for a memory, it passes trough a ‘one-way’ valve into the secure memory vault but not into a secure memory capsule. Memories can only be placed in a secure memory message capsule after the subscriber has entered the highest security zone by successfully challenging the pre-established security barriers. These security barriers typically include biometric authentication and one-time access codes sent to a separate second communications channel (i.e.: if the subscriber is using the main computer, the one-time access code is dispatched through the subscriber's mobile device).

The permanent memory message capsule zone maintains a subscriber's memories in an encrypted secure state for themselves and for any individuals designated as beneficiaries. Memory messages and other information a subscriber wants to secure are uploaded from the daily work zone as directed by the subscriber. During the initialization process, the subscriber has set the security level desired to protect the memory message capsules and has designated the specific memory capsules accessible by individual beneficiaries. The memory message capsules are segregated within the proprietary servers and are not accessible unless the security protection set up in the initialization process is successfully challenged by the subscriber or a designated beneficiary. There are three levels of security available: mild, strong and extreme with the subscriber setting the level desired depending on perceived need for security. The ‘mild’ security setting is comparable to the secure processes used by banks and other financial institutions.

The initialization process for subscribers includes designating individuals as registered beneficiaries allowed to share in the subscriber's memories. Beneficiaries are anyone the subscriber wants to leave a message to or share memories with, and would usually include life partners and children, other family members, executor, power of attorney, designate under an advanced health care directive (living will), etc. Business partners, close friends and acquaintances can also be beneficiaries. The subscriber selects the memory message capsules relevant to each beneficiary and the level of security that will protect the specific memory capsule. The subscriber specifies a user name and email address for each beneficiary. Challenge procedures allow for authentication of beneficiaries even if email addresses or computer identification has changed over time and not been updated.

An inherent security feature is that information is only stored on proprietary servers and never released to the ‘cloud’. There will be online backup servers in secure locations with multiple fibre sources, generator backup, earthquake protection, etc. When a memory is to be deleted, the physically contiguous section of the server containing the memory is reformatted or overwritten so no trace of the memory remains, even under forensic investigation.

The Web site is essentially an electronic version of selected portions of a subscriber's memory. On confirmation of death or incapacity of a subscriber, beneficiaries may receive email notification from the Web site of their registered status, a specific id card may be located with the subscriber's personal effects or the beneficiaries may have been notified by the subscriber at some earlier time. Beneficiaries receive a one-time access code automatically from the Web site server or request a one-time access code from the Web site by submitting an authenticated death certificate number and, after authentication, receive the security challenge test previously set by the subscriber for the specific beneficiary. Successful completion of the security challenge provides access to the specific memories previously authorized by the subscriber.

Beneficiary access may also be achieved when a subscriber is incapacitated through disappearance or illness like stroke or dementia. A preselected group of incapacitation contacts designated by the subscriber would confirm that the subscriber is unable to act. At least one arms-length independent party is required in each incapacity challenge group.

Security requirements are tailored to meet the subscriber's perception of the strength of security required. Suggested beneficiary challenge questions are multiple choice style to avoid failure based on non-identical answers. Security levels are made stronger by increasing the number of questions.

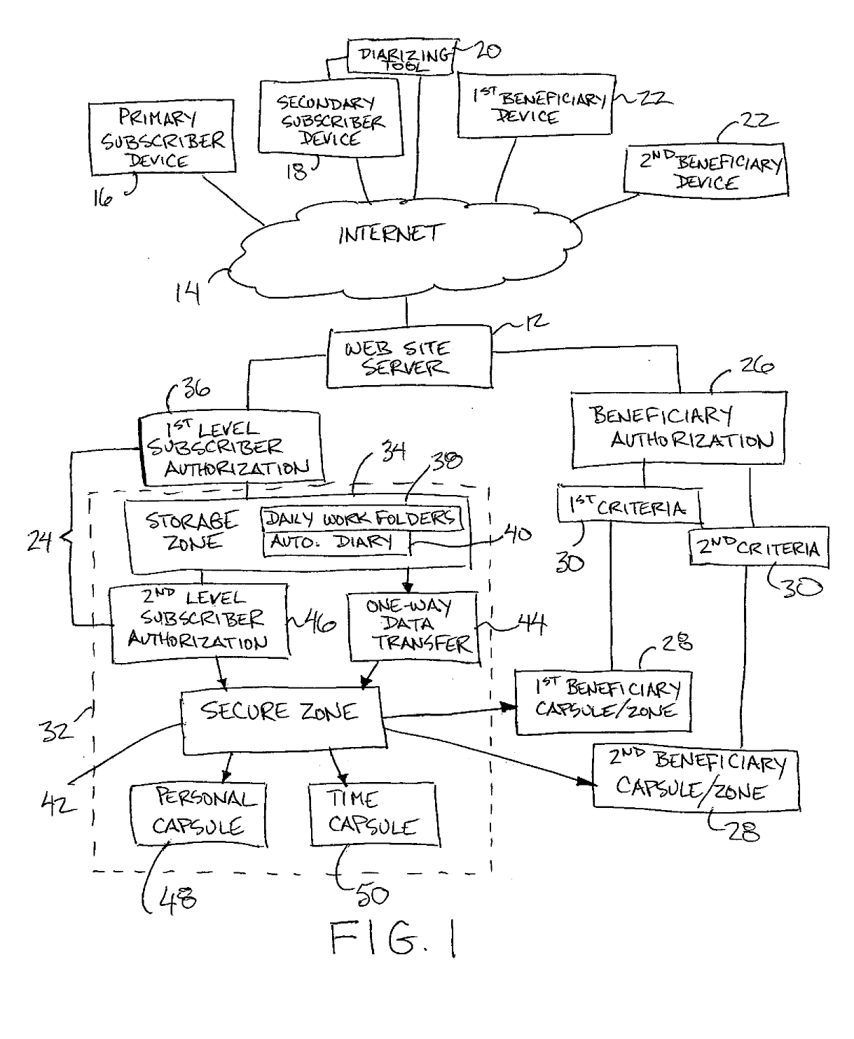

Turning now more particularly to the Figures, a schematic representation of the computer implemented system for storing digital memories of a subscriber for subsequent access by a beneficiary is shown in FIG. 1. The system generally comprises a proprietary website server 12 having a communication interface which provides the sole communication between the information stored on the servers and the internet.

The server 12 communicates over the internet 14 with various subscriber computing devices which may include a primary subscriber device 16, for example a personal home computer, and a secondary subscriber device 18, for example a mobile phone with appropriate application software thereon. The subscriber devices are internet enabled and include appropriate software components executable thereon by the system for encrypting various forms of information such as voice, photos, videos, or various text documents into digital memories transferred in a secure manner over the internet to the proprietary website server 12. At least one of the subscriber devices, preferably a mobile device, includes a diarizing tool 20 which can automatically update various information from emails and calendars and the like over the Internet to the subscriber's respective zone within the website server as described in further detail below.

Digital memories belonging to the subscriber are stored on the website server through communication with the subscriber devices for subsequent retrieval by one or more beneficiaries having their own respective beneficiary computing devices 22 which are internet enabled for communication over the internet to the website server 12 also. The communication interface of the website server includes a subscriber authentication component 24 and a beneficiary authorization component 26 to authorize various communications of the subscriber and the respective beneficiaries as described in further detail below.

Typically a subscriber initially subscribes to the service of the server 12 by submitting an application with the appropriate fee. The system then sets up a profile for the subscriber and collects various information such as an internet address and machine identifier for each of the subscriber's computing devices 16 and 18, as well as monitoring inputs by the subscriber to determine a biometric rhythm profile to be compared to in future for authenticating the subscriber at various levels. Identity of the subscriber can be further accomplished and confirmed at initial setup and subscription by sending a single use set up password code to the subscriber through a pre-arranged separate mode of communication such an email to a pre-arranged address which the subscriber then enters into the website server to confirm their identity when recording machine identifiers of authorized computing devices for example.

Further steps in the setup process may include various selections made by the subscriber with regard to the diarizing tool to determine what sources of information are automatically diarized such as emails, specific folders of photos or other data, and calendar entries for example.

In addition to selecting what content is uploaded from the subscriber devices to the website server, the subscriber also sets up one or more beneficiary capsules 28. Each beneficiary capsule comprises a segregated zone for storage of information to be shared with one or more beneficiaries designated to be authorized to view the content of that capsule. The subscriber also sets various beneficiary authorization criteria 30 to be associated with each beneficiary capsule with which the beneficiary is to be associated. The beneficiary authorization criteria 30 typically comprises personalized information which is specific to the particular designated beneficiary.

When logged in to the website server 12, the subscriber typically communicates with a subscriber zone 32 within the server which is segregated from other zones and is only authorized for access by the associated subscriber. Within the subscriber zone, there is provided a storage zone 34 which is accessed with a first level of subscriber authorization criteria 36. The storage zone 34 receives various digital memories chosen by the subscriber for upload when logged in to the website server and is intended for more frequent day-to-day interactions so that daily work files 38 can be stored therein and readily accessed with a first level of authorization.

The storage zone is also the destination for any content which is automatically uploaded by the diarizing tool 20 so that the automatically diarized content 40 can also be readily accessed with only the first level subscriber authorization criteria 36 being met.

Once access is provided to the storage zone, the subscriber can select different portions of data to be sent to a secure zone 42 having a higher level security. A data transfer tool 44 permits data to be transferred in a single direction from the storage zone to the secure zone without requiring a second level subscriber authorization criteria 46 being met. If the user wishes to access data which has already been transferred to the secure zone however, the content in the secure zone can only be accessed once the second level subscriber authorization criteria 46 has been met.

Typically the second level subscriber authorization criteria are more strict than the first level. For example, the second level subscriber authorization criteria may include comparing biometric rhythm profiles of the subscriber or a single access code sent separately to the subscriber. The second level criteria may also require matching a specific internet address and/or machine identifier relating to one specific subscriber device 16 or 18. By contrast the first level subscriber authorization may only comprise a single criteria being met or may involve more general passwords for example as compared to the second level authorization criteria.

Once the subscriber has accessed the secure zone, the subscriber can make selections as to what portion of the content is transferred to the different beneficiary capsules 28 which have already been set up. Alternatively the subscriber can add new beneficiary capsules as desired simply by specifying the associated beneficiaries and the respective beneficiary criteria 30 to be associated therewith.

Within the secure zone the subscriber may also create a personal capsule 48 which is segregated from the other capsules and remains private to the subscriber.

The subscriber may also designate a time capsule 50 in the form of a further segregated zone for storage of data, but with different criteria for access being prescribed. In particular, the time capsule is designated for release to one or more beneficiaries at a designated time in the future once the prescribed duration has elapsed. Access to the content of the designated beneficiaries may be similar to the beneficiary capsules described above.

The content left in the beneficiary capsules typically becomes available to the respective designated beneficiaries only upon one of two conditions being met. The conditions include either the death of the subscriber being confirmed or the incapacitation of the subscriber being confirmed. Confirmation of incapacitation can only occur if a group of incapacitation contacts preselected by the subscriber can confirm the incapacitation.

Once the above conditions have been met, all beneficiaries designated by the subscriber are notified of the respective beneficiary capsules. To access the content, the beneficiaries must, submit a death certificate number for the subscriber and receive, after authentication, a single use code from the website server 12 which is then transmitted to the beneficiary through a separate communication means which is prearranged by the subscriber. The single use code can then be entered by the respective beneficiary into the website server to grant access to the respective beneficiary authorization criteria 30. The criteria typically comprise a series of challenge questions which are intended to be personalized to the beneficiary. Once the challenge questions have been met, the beneficiary then gains access to the digital memory stored within the respective capsule 28 within the beneficiary zone of the proprietary server.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A computer implemented system for storing digital memories of a subscriber using an internet enabled subscriber computing device for access by a beneficiary using an internet enabled beneficiary computing device, the system comprising:
a proprietary server comprising a subscriber zone associated with the subscriber and which includes subscriber authorization criteria associated therewith and at least one beneficiary zone associated with said subscriber zone which includes beneficiary authorization criteria relating to a beneficiary associated therewith;
a communication interface arranged to provide sole communication between the proprietary server and the internet, the communication interface comprising:
a subscriber authentication component arranged to authorize a subscriber to upload digital memories over the internet to the subscriber zone of the proprietary server and to transfer digital memories from the subscriber zone to one beneficiary zone of the proprietary server associated with said subscriber zone using the subscriber computing device in response to the subscriber authorization criteria being met; and
a beneficiary authentication component arranged to authorize a beneficiary to access digital memories only from the beneficiary zone associated therewith using the beneficiary computing device in response to the beneficiary authorization criteria being met.

2. The system according to claim 1 wherein the beneficiary authentication component is arranged to be activated only in response to a prescribed subscriber condition criteria being met.

3. The system according to claim 2 wherein the prescribed subscriber condition criteria comprises a confirmed death of the subscriber.

4. The system according to claim 1 wherein the prescribed subscriber condition criteria comprises an incapacitation of the subscriber as confirmed by a preselected group of incapacitation contacts.

5. The system according to claim 1 wherein the subscriber authentication component of the communication interface comprises a website server system.

6. The system according to claim 1 wherein the beneficiary authentication component of the communication interface comprises a website server system.

7. The system according to claim 1 wherein the subscriber authorization criteria includes an identity of the subscriber encrypted with a unique random number and a number of hash iterations.

8. The system according to claim 1 wherein the subscriber authorization criteria includes a machine identification corresponding to the subscriber computing device.

9. The system according to claim 1 wherein the subscriber zone comprises a storage zone arranged to receive digital memories from the subscriber computing device and a secure zone arranged to receive digital memories from the storage zone prior to transfer to the beneficiary zone, each of the storage zone and the secure zone having respective subscriber authorization criteria associated therewith.

10. The system according to claim 9 wherein the subscriber zone further comprises a data transfer component arranged to transfer digital memories only from the storage zone to the secure zone if the subscriber authorization criteria associated with the storage zone has been met but the subscriber authorization criteria associated with the secure zone has not been met.

11. The system according to claim 9 wherein the subscriber authorization criteria associated with the secure zone requires a higher degree of authorization than the subscriber authorization criteria associated with the storage zone.

12. The system according to claim 9 wherein the subscriber authorization criteria associated with the secure zone includes biometric rhythm criteria associated with the subscriber.

13. The system according to claim 9 wherein the subscriber authorization criteria associated with the secure zone includes a one-time access code which is valid for a single use, the subscriber authorization component being arranged to generate the one-time access code and transmit the one-time access code to the subscriber independently of the communication interface.

14. The system according to claim 1 for use with a plurality of beneficiaries using respective beneficiary computing devices, wherein the proprietary server includes a plurality of beneficiary zones associated with said subscriber zone, the plurality of beneficiary zones having different beneficiary authorization criteria associated therewith corresponding to different ones of the beneficiaries being authorized to access the digital memories stored therein.

15. The system according to claim 1 wherein the beneficiary authorization criteria includes challenge questions prescribed by the subscriber which are personalized to the respective beneficiary.

16. The system according to claim 1 wherein the beneficiary authorization criteria includes a one-time access code which is valid for a single use, the beneficiary authorization component being arranged to generate the one-time access code and transmit the one-time access code to the beneficiary independently of the communication interface.

17. The system according to claim 1 wherein the proprietary server further comprises a time capsule component associated with said subscriber zone and being arranged to receive digital memories from the subscriber zone and store the digital memories in encrypted form therein, the time capsule component being arranged to provide an authorized beneficiary access to the information upon expiry of a prescribed duration.

18. The system according to claim 1 further comprising a subscriber storage tool arranged to be executed on the subscriber computing device, the subscriber storage tool being arranged to automatically transfer digital memories in encrypted form from the subscriber computing device to the subscriber zone in response to subscriber interactions with the subscriber computing device.

19. The system according to claim 18 wherein the subscriber zone comprises a storage zone arranged to receive digital memories from the subscriber storage tool and a secure zone arranged to receive digital memories from the storage zone prior to transfer to the beneficiary zone, the subscriber storage tool only being authorized to transfer digital memories to the storage zone.

20. A method for storing digital memories of a subscriber for access by a beneficiary using an internet enabled beneficiary computing device, the method comprising:
providing an internet enabled subscriber computing device;
providing a proprietary server comprising a subscriber zone associated with the subscriber and which includes subscriber authorization criteria associated therewith and at least one beneficiary zone associated with said subscriber zone which includes beneficiary authorization criteria relating to the beneficiary associated therewith;
providing a communications interface arranged to provide sole communication between the proprietary server and the internet, the communications interface comprising a subscriber authentication component and a beneficiary authentication component;
receiving digital memories uploaded over the internet to the subscriber zone of the proprietary server from a subscriber using the subscriber computing device and being authorized by the subscriber authentication component in response to subscriber authorization criteria being met;
transferring the digital memories from the subscriber zone to at least one beneficiary zone associated with said subscriber zone in response to instructions from the subscriber using the subscriber computing device and being authorized by the subscriber authentication component in response to subscriber authorization criteria being met;
arranging only the digital memories from the beneficiary zone associated the beneficiary to be accessed by the beneficiary authorized by the beneficiary authentication component in response to beneficiary authorization criteria being met.
